(19) United States
(12) Patent Application Publication
(10) Pub. No.: US 2019/0286504 A1
(43) Pub. Date: Sep. 19, 2019

(54) GRAPH-BASED ROOT CAUSE ANALYSIS

(71) Applicant: CA, Inc., New York, NY (US)

(72) Inventors: Victor Muntés-Mulero, Sant Feliu de Llobregat (ES); Marc Solé Simó, Barcelona (ES); David Solans Noguero, Barcelona (ES); Alberto Huelamo Segura, Barcelona (ES)

(21) Appl. No.: 15/933,263

(22) Filed: Mar. 22, 2018

(30) Foreign Application Priority Data
Mar. 15, 2018 (ES) P201830258

(51) Int. Cl. G06F 11/07

(52) U.S. Cl. CPC G06F 11/079; G06F 11/0751; G06F 11/0709

(57) ABSTRACT

To aid in the root cause analysis of current system errors or anomalies, a graph-based root cause analysis software determines whether a graph representing an anomalous region of a system, referred to as a pattern, is similar to a previously stored pattern in a pattern library. The analysis software extracts a sub-graph or pattern representing components currently experiencing an anomaly from an overall system graph. The analysis software calculates a similarity score based on the comparison of the extracted pattern to patterns in the pattern library. The patterns in the pattern library represent previously encountered anomalies and include attributes, event data, expert/system administrator notes, etc., that can aid in diagnosing the current system anomaly.

### BACKGROUND

The disclosure generally relates to the field of data processing, and more particularly to computer system monitoring and root cause analysis.

Information related to interconnections among components in a system is often used for root cause analysis of system issues. For example, a network administrator or network management software may utilize network topology and network events to aid in troubleshooting issues and outages. Network topology typically describes connections between physical components of a network and may not describe relationships between software components. Events are generated by a variety of sources or components, including hardware and software. Events may be specified in messages that can indicate numerous activities, such as an application finishing a task or a server failure.

### BRIEF DESCRIPTION OF THE DRAWINGS

Aspects of the disclosure may be better understood by referencing the accompanying drawings.

FIG. 1 depicts an example system for diagnosing anomalous events using graph-based root cause analysis.

FIG. 2 depicts an example pattern which may be stored in a pattern library.

FIG. 3 depicts an example interface which displays a mapping between two patterns and allows for adjustment of node weights.

FIG. 4 depicts a flowchart with example operations for performing graph-based root cause analysis.

FIG. 5 depicts an example mapping of elements between a pair of patterns.

FIG. 6 depicts an example mapping of elements between a pair of patterns.

FIG. 7 depicts a flowchart with example operations for mapping elements between two graphs.

FIG. 8 depicts an example of combining equivalent nodes into a single representative node to reduce an algorithmic search space.

FIG. 9 depicts a flowchart with example operations for reducing a pattern using classes.

FIG. 10 depicts an example computer system with a graph-based root cause analyzer.

### DESCRIPTION

The description that follows includes example systems, methods, techniques, and program flows that embody aspects of the disclosure. However, it is understood that this disclosure may be practiced without these specific details. For instance, this disclosure refers to performing root cause analysis on system graphs representing computer systems and networks in illustrative examples. But aspects of this disclosure can be applied to performing root cause analysis in other domains such as mechanical systems, corporate structures and entities, etc. In other instances, well-known instruction instances, protocols, structures, and techniques have not been shown in detail in order not to obfuscate the description.

### Terminology

The term “component” as used in the description below encompasses both hardware and software resources. The term component may refer to a physical device such as a computer, server, router, etc.; a virtualized device such as a virtual machine or virtualized network function; or software such as an application, a process of an application, database management system, etc. A component may include other components. For example, a server component may include a web service component which includes a web application component.

The description below uses the term “system graph” to refer to a data structure that depicts connections or relationships between components. A system graph consists of nodes (vertices, points) and edges (arcs, lines) that connect them. A node represents a component, and an edge between two nodes represents a relationship between the two corresponding components. Nodes and edges may be labeled or enriched with data. For example, a node may include an identifier for a component, and an edge may be labeled to represent different types of relationships, such as a hierarchical relationship or a cause-and-effect type relationship. In some implementations, a node may be indicated with a single value such as (A) or (B), and an edge may be indicated as an ordered or unordered pair such as (A, B) or (B, A). System graphs may be represented by a variety of data structures such as adjacency lists, adjacency matrices, incidence matrices, etc. In implementations where nodes and edges are enriched with data, nodes and edges may be indicated with data structures that allow for the additional information, such as JavaScript Object Notation (“JSON”) objects, extensible markup language (“XML”) files, etc. A system graph may also be referred to in related literature as a context graph, a component graph, a triage map, relationship diagram/chart, causality graph, knowledge graph, etc.

The description below refers to an indication of an event (“event indication”) to describe a message or notification of an event. An event is an occurrence in a system or in a component of the system at a point in time. An event often relates to resource consumption and/or state of a system or system component. As examples, an event may be that a file was added to a file system, that a number of users of an application exceeds a threshold number of users, that an amount of available memory falls below a memory amount threshold, or that a component stopped responding or failed. An event indication can reference or include information about the event and is communicated to by an agent or probe to a component/agent/process that processes event indications. Example information about an event includes an event type/code, application identifier, time of the event, severity level, event identifier, event description, etc.

Overview

As a system increases in size and complexity, it becomes increasingly difficult to monitor and timely perform analysis of system issues or conditions. Additionally, as problems are diagnosed, it is difficult to leverage information learned from previous solutions other than relying on a system administrator's own expertise or memory. To aid in the root cause analysis of current system errors or anomalies, a graph-based root cause analysis software determines whether a graph representing an anomalous region of a system, referred to as a pattern, is similar to a previously stored pattern(s) in a pattern library. The analysis software extracts a sub-graph or pattern representing components currently experiencing an anomaly from an overall system graph. The analysis software calculates a similarity score based on the comparison of the extracted pattern to patterns in the pattern library. The patterns in the pattern library represent previously encountered anomalies and include attributes, event data, expert/system administrator notes, etc., that can aid in diagnosing the current system anomaly.

Given the complexity of the extracted patterns, determining a similarity between a pair of patterns can be a computationally expensive and time-consuming process. To reduce the similarity calculation costs, patterns can be simplified based on equivalent classes of components. A similarity score can be calculated between nodes of a pattern. The nodes which represent a same component type and have similar attributes will likely have a high similarity score and can be combined into a single node representing the entire class of the components. The decision to combine nodes also considers a node's topological features such as relationships and connections to other nodes. By combining equivalent nodes, the search space for mapping and determining similarity between two graphs can be reduced. Reducing the search space, exponentially reduces the number of iterations required for determining an optimal similarity score and improves the performance and scalability of the overall root cause analysis framework.

### Example Illustrations

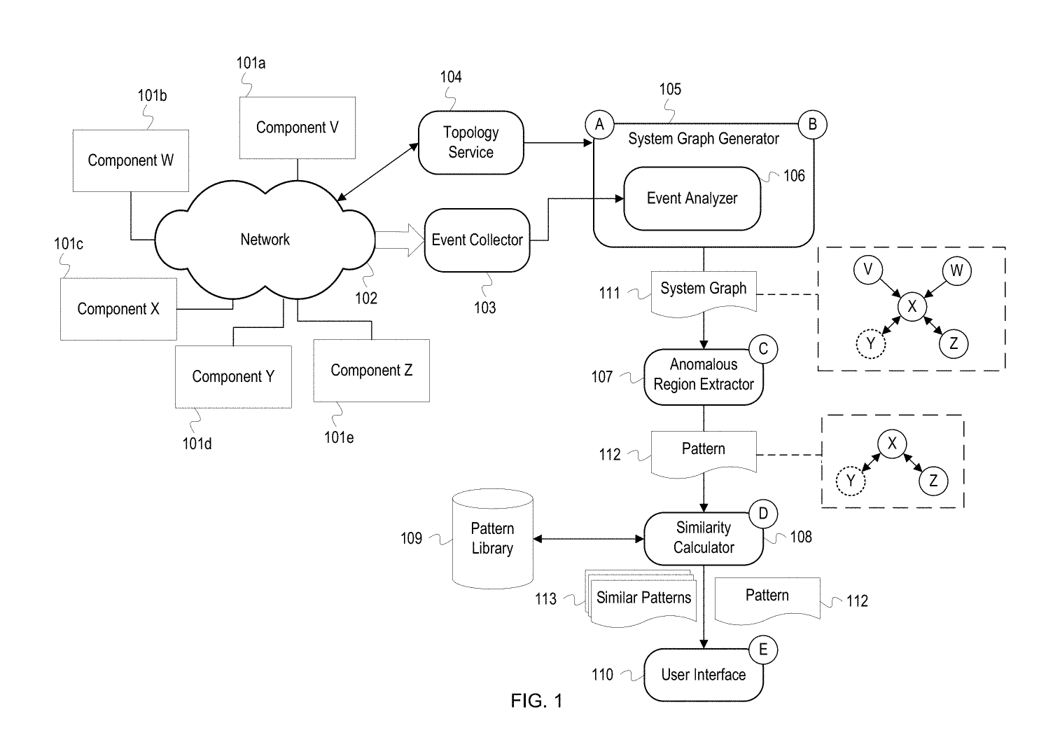

FIG. 1 depicts an example system for diagnosing anomalous events using graph-based root cause analysis. FIG. 1 depicts a system graph generator 105 (“generator 105”), an anomalous region extractor 107 (“extractor 107”), a similarity calculator 108, a pattern library 109, and a user interface 110. The generator 105 includes an event analyzer 106. The generator 105, extractor 107, similarity calculator 108, and user interface 110 are software processes that may execute on a server or host as part of a network manager or analysis application. FIG. 1 also depicts a component V 101a, a component W 101b, a component X 101c, a component Y 101d, and a component Z 101e (“the components 101”). The components 101 are connected to a network 102 and communicate with an event collector 103 and a topology service 104.

At stage A, the generator 105 receives topology data from the topology service 104. The topology data describes the arrangement of the components 101 in the network 102. Typically, topology data indicates the arrangement of physical networking components such as servers, routers, switches, or storage devices and may, in some instances, also indicate the arrangement of logical or virtualized network components such as virtual routers or switches. The topology service 104 may generate the topology information using data input by a network administrator, by analyzing OSI Layer 3 or NetFlow data, using network discovery or mapping tools, or any combination of the above. The topology service 104 may monitor the network 102 and maintain the topology data as new components are added or removed from the network. The generator 105 may communicate with the topology service 104 and request the topology data using various communication protocols, such as Hypertext Transfer Protocol (HTTP) REST, Simple Network Management Protocol (SNMP), or an application program interface (API). The generator 105 may subscribe to the topology service 104 to receive notifications as changes are made to the topology data. For example, the topology service 104 may maintain a list of subscribers' Internet Protocol (IP) addresses and push network topology updates to the subscribers.

Also, at stage A, the generator 105 receives event indications from the event collector 103. The components 101 either directly or via monitoring agents generate event indications/messages that are received by the event collector 103. The components 101 may be a variety of hardware resources, such as hosts, servers, routers, switches, databases, etc., or software resources, such as web servers, virtual machines, applications, programs, processes, database management systems, etc. The components 101 are connected to the network 102 which may be a local area network, a wide area network, or a combination of both. The components 101 may be instrumented with agents or probes (not depicted) that monitor the components 101 and generate event indications that specify or otherwise describes events that occur at or in association with one of the components 101. For example, an event indication may indicate an action performed by a component such as invoking another component, storing data, restarting, etc. Event indications may also be used to report performance metrics such as available memory, processor load, storage space, network traffic, etc. The agents generate and send the event indications to the event collector 103. The event collector 103 may be a part of an event management system that includes multiple event collectors and other event processing code. After receiving the event indications, the event collector 103 may store the event indications in an event database that acts as a log of events that have occurred and been detected in the network 102 or may otherwise communicate the event indications to the generator 105.

At stage B, the generator 105 generates a system graph 111 based on the received event indications and topology data. The system graph 111 is a data structure that models physical, functional, and event-based relationships between the components. The generator 105 generates the context graph 111 by combining component relationship information derived from (1) the topology data provided by the topology service 104 and (2) event analysis of the event analyzer 106. The generator 105 analyzes the topology data to identify the components 101 and physical and/or logical connections between the components 101. The generator 105 generates a node for each component in the system graph 111 and generates edges between the nodes as necessary to represent the physical and/or logical connections between the components 101. Additional nodes and relationships can be derived from analysis of the event indications. The event analyzer 106 analyzes event indications received from the event collector 103 and can determine event-based component relationships not indicated in the topology data. For example, the event analyzer 106 may determine there is a relationship between the component X 101c and the component Y 101d based on analyzing an event which indicates that the component X 101c invoked or called the component Y 101d. This relationship may not be indicated in the topology data for a variety of reasons, such as the components 101c and 101d not being represented in the topology data or not being physically or logically connected.

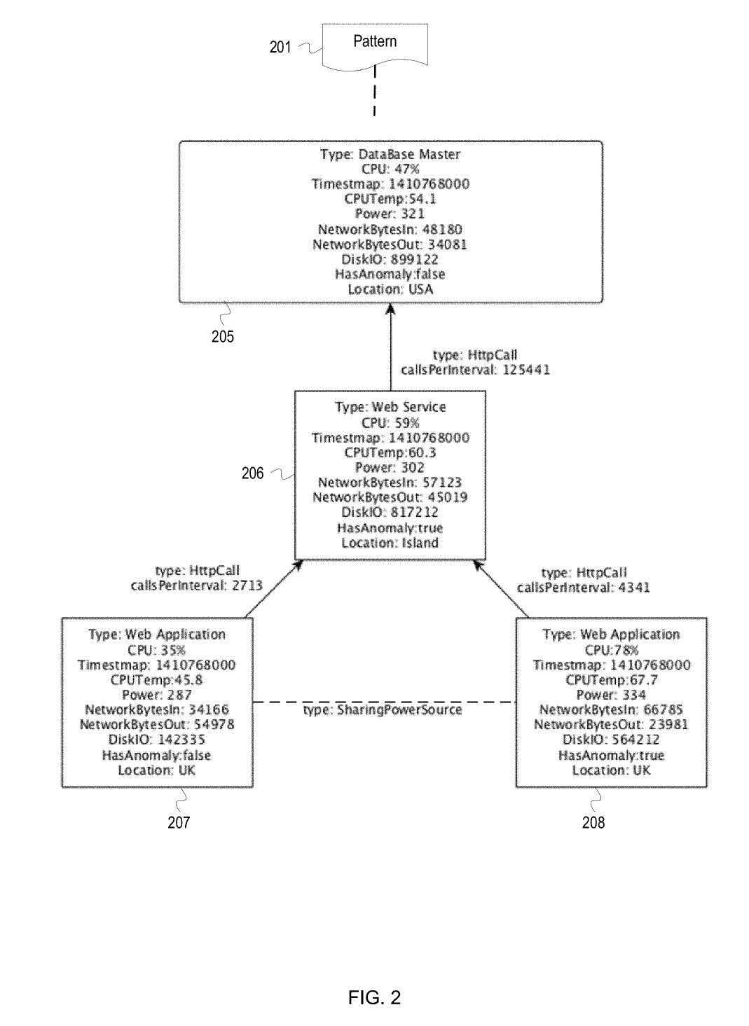

As shown in more detail in FIG. 2, the generator 105 also enriches the nodes and edges of the system graph 111 with attributes, performance metrics/measurements, event data, logs, etc., corresponding to the components and relationships represented by the nodes and edges. The attribute information may be categorical, numerical, ontological, phylogenetic, etc. The generator 105 also identifies nodes which are experiencing/have experienced an anomalous event. An anomalous event is an event that indicates a network occurrence or condition that deviates from a normal or expected value or outcome. For example, an event may have an attribute value that exceeds or falls below a determined threshold or required value, or an event may indicate that a component shut down or restarted prior to a scheduled time. Additionally, an anomalous event may be an event that indicates a network issue such as a component failure. In FIG. 1, the component Y in the system graph 111 is depicted with a dashed line to indicate that the component Y 101c has experienced an anomalous event. After generating the system graph 111, the generator 105 passes the system graph 111 to the extractor 107.

At stage C, the extractor 107 extracts a pattern 112 which represents an anomalous region of the system graph 111. The extractor 107 identifies components which have encountered an anomalous event based on event data and logs or based on data from the generator 105, such as the indication that component Y is anomalous. The extractor 107 extracts a region or sub-graph of the system graph 111 that encompasses the anomalous component Y for the pattern 112. In FIG. 1, the extractor 107 selects the nodes and edges for the components X, Y, and Z to comprise the pattern 112. The extractor 107 may be programmed to select nodes connected to the anomalous node based on a threshold graph distance (e.g., select nodes which are 2 or fewer edges away). The extractor 107 may also analyze attributes and events for the anomalous component Y and select components with similar attributes or events. For example, the node X and Y may both represent a same type of component and have similar attributes. Additionally, the extractor 107 can determine whether the node Y is part of a sub-system and select all components corresponding to the sub-system. For example, if the node Y is a database in a database cluster, the extractor 107 selects the node Y and all other nodes which represent databases in the cluster and other related components, such as the database management system.

If the system graph 111 indicates multiple anomalies, the extractor 107 can extract a pattern for each anomalous region from the system graph 111 as described above. In some implementations, the extractor 107 identifies interrelated anomalies and includes them in a single pattern. The extractor 107 may determine that anomalies are interrelated if the anomalies occurred within a same time period or within a same sub-system of components which each experienced a same type of anomaly. However, even if the anomalies occur within a same time window or are of a same type, the extractor 107 may treat the anomalies as independent situations (i.e., extract different patterns for each anomalous region) if the affected components are not connected or are separated by a threshold distance in the system graph 111. The extractor 107 may track the frequency with which seemingly independent anomalies occur. If two or more independent anomalies frequently occur within a same time window, the extractor 107 can determine that there is a relationship between the anomalies, even if the affected components are disconnected in the system graph 111. The extractor 107 may extract a pattern from the system graph 111 with two or more disconnected regions to represent the separate, but potentially related, anomalous regions. After extracting the pattern 112, the extractor 107 passes the pattern 112 to the similarity calculator 108.

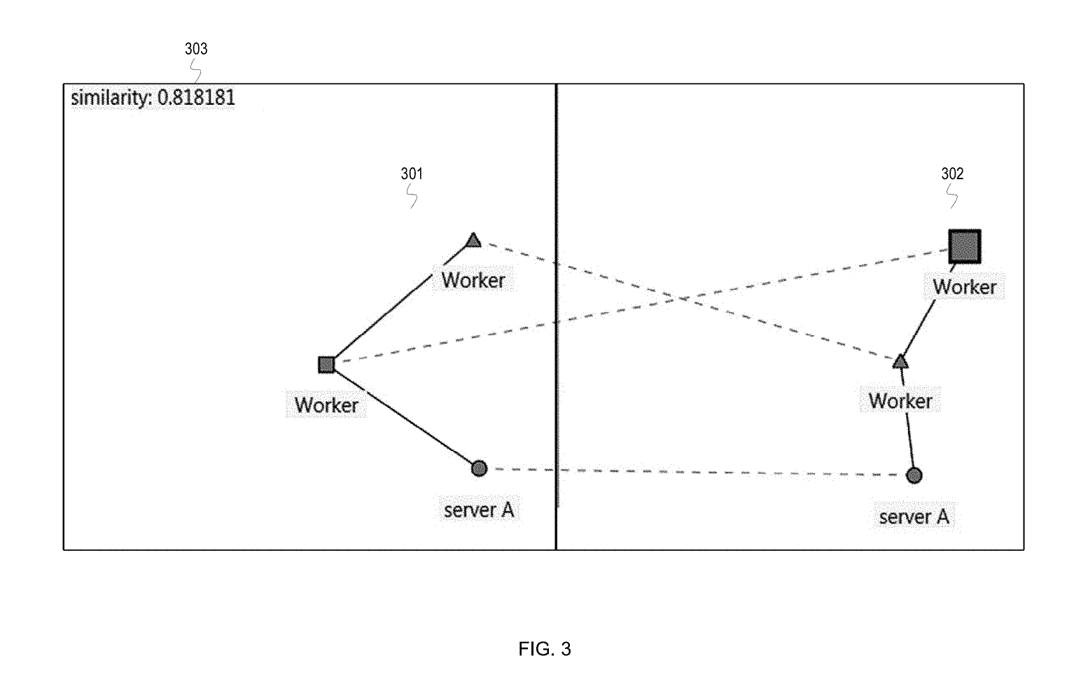

At stage D, the similarity calculator 108 compares the pattern 112 and patterns in the pattern library 109 to identify similar patterns 113. The pattern library 109 includes extracted patterns of anomalous regions previously experienced in the system of FIG. 1. Because the patterns in the pattern library 109 represent previous states of the components 101, the patterns in the pattern library 109 may be referred to as historical patterns. The patterns in the pattern library 109 may be annotated with notes from a system administrator or other diagnostic data which indicates an ultimate root cause of the anomalies indicated in the similar patterns 113. For example, the diagnostic data may include solutions to solving an anomaly, such as adjusting a load balancing algorithm, restarting a server, adding more storage devices, adding more memory to a component, etc. As a result, matching the pattern 112 to a pattern in the pattern library 109 can lead to a diagnosis of the anomalies occurring in the pattern 112. The similarity calculator 108 uses an algorithm to calculate a similarity score between the pattern 112 and patterns in the pattern library 109. For example, the similarity score may be calculated using graph path-finding heuristic-based algorithms, such as the A* algorithm. Additionally, as shown in FIG. 3, the similarity calculator 108 generates a mapping between patterns that contains one-to-one mappings of nodes and edges in the compared patterns. In general, two patterns are similar if the patterns contain same types of components with similar relationships. A similarity score can also be affected by similarity of attributes, performance metrics, event logs, etc. For example, two components of different types may still be considered similar if event logs for the components indicate that the components each invoked a same authentication service. Additionally, the patterns in the pattern library 109 may be weighted to emphasize or diminish the effect of particular attributes or components when calculating similarity scores. For example, if processor usage was considered a main factor for an anomaly such as a system slowdown, the processor usage attribute for a component in a pattern may be weighted more heavily to cause a similarity score to be higher if a component being compared has a similar processor usage attribute value or lower if the value is different.

A similarity score may be calculated using the following example similarity function. Given two graphs to be compared, the output of the similarity function consists of two values, a similarity score (e.g., a percentage value or a value between 0 and 1) and a mapping of pairs of elements from one graph and the other. Each mapping connects graph elements with high similarity. Once the mapping is determined, the similarity function calculates the similarity value between the two graphs as the sum of the similarities of each pair of mapped/matched elements minus a certain value for each element that was not mapped. Two graphs, G1 and G2, comprising nodes/vertices and edges can be defined as follows:

G1=(V1,E1);G2=(V2,E2) (1)

A mapping function that returns the mapped element from G2 for each element of G1 can be define as follows:

m=V1∪E1→V2∪E2 (2)

Such a mapping is consistent if the source and target nodes of a mapped edge, coincides with the mapped nodes of the original edge. If an edge is represented as a tuple of nodes, i.e., e=(n1, n2), then a consistent mapping m is a mapping such that for all mapped edges e=(n1, n2) with m(e)=(na, nb), it holds that m(n1)=na and m(n2)=nb. A weight function that returns the attached weight of a given element can be defined as follows:

w(x)=weight(x) (3)

A function that returns all the attributes to be compared in the similarity function for a graph element x can be defined as follows:

att(x)=list of attributes(x) (4)

As shown below, the similarity for two graphs can be computed as the weighted average of similarities between mapped nodes and edges. Function (5) defines a similarity function for graphs G1 and G2, SIM(G1, G2). Function (5) uses a mapping function m(x) which takes a graph element from G1 as an argument and returns a graph element from G2 to which the graph element from G1 is mapped. Function (5) also uses a weight function, such as the weight function (3) above. In Function (5), v and e indicate nodes and edges, respectively. The arguments V₁ and E₁ reference nodes and edges from graph G1, and V2 and E2 reference nodes and edges from graph G2:

$$SIM ( G 1 , G 2 ) = \frac{\begin{matrix}{\sum }_{v ∈ {V}_{1}}^{ } ( w ( v ) + w ( m ( v ) ) \cdot sim ( v , m ( v ) ) + \\ {\sum }_{e ∈ {E}_{1}}^{ } ( w ( e ) + w ( m ( e ) ) \cdot sim ( e , m ( e ) )\end{matrix}}{{\sum }_{v ∈ {V}_{1}}^{ } w ( v ) + {\sum }_{v ∈ {V}_{2}}^{ } w ( v ) + {\sum }_{e ∈ {E}_{1}}^{ } w ( e ) + {\sum }_{e ∈ {E}_{2}}^{ } w ( e )} \qquad ( 5 )$$

Function (5) also relies on a similarity function, sim(u, v), which returns the similarity between two graph elements (i.e., nodes or edges), as defined in function (6). In function (6), u and v are elements from two graphs (e.g., G1 and G2), a1 and a2 are shared attributes of those elements, and va and ua represent the values of attribute a in v and u respectively:

$$sim ( u , v ) = \frac{{\sum }_{a ∈ att ( v ) ⋂ att ( u )}^{ } ( w ( a 1 ) + w ( a 2 ) ) \cdot similarity ( va , ua )}{{\sum }_{a ∈ att ( v ) ⋃ att ( u )}^{ } ( w ( a 1 ) + w ( a 2 ) )} \qquad ( 6 )$$

Function (6) indicates that the similarity of an element is a weighted average between the shared attributes of the elements related by the mapping. Function (6) makes use of a weight function, e.g. w(a1), which returns a weight assigned to a given attribute. The function similarity(va, ua) in function (6) returns a value indicating a similarity score or value of the two attributes, such as a difference or a percentage difference in the attribute values. When comparing numerical attribute values, the values may be rounded or compared up to a specified decimal place, such as hundredths or thousandths. When comparing strings or characters, differing degrees of comparison may be used such as whether the strings are an exact match, whether one string includes another, etc. When using exact match, for example, the strings may be given a similarity value of 0 if the two strings are not an exact match and a 1 if they are an exact match. If partial matches are allowed, such as a first string containing another string (e.g., comparing component type attributes “Database Manager” and “Database”), a similarity score of 0.5 may be used if the strings are a partial match.

As illustrated in the above functions, there are tiers of similarity scores or values which contribute to an overall similarity score for two graphs, i.e. a graph similarity score is based on element similarity scores which are based on attribute similarity scores. The above similarity functions are examples of possible functions that satisfy the given approach, but other functions could be used as well. For example, function (6) penalizes a similarity score for non-shared attributes but may be altered to ignore non-shared attributes and consider only the shared ones. In some implementations, a similarity score for two graph elements may be equal to an average difference between attribute values of the two elements. The similarity score for two graphs may similarly be equal to the average difference between attribute values of all mapped elements. Graphs or elements with a larger average difference are more dissimilar than those with a lower average difference.

After calculating the similarity scores, the similarity calculator 108 determines which similarity scores exceed a threshold. The corresponding patterns from the pattern library 109 whose similarity scores exceed the threshold (e.g. greater than 80%) are selected as the similar patterns 113. The threshold is a configured value that can vary based on a domain of a given system or based on a type of component experiencing an anomaly. For example, a threshold for a data center may be lower than a threshold for a security system. If the component type experiencing an anomaly is a commoditized component, such as a server, the threshold may be higher than for a more specialized component, such as thermal sensor. If no patterns in the pattern library 109 exceed the similarity score threshold, the extractor 107 determines that the pattern 112 is unique and should be added to the pattern library 109. The addition of unique patterns enables the pattern library 109 to grow and become more useful over time. In some instances, multiple similarity thresholds may be used to control separately when a pattern is added to the pattern library 109 and when a pattern is considered a similar pattern. For example, a lower threshold of 60% and a higher threshold of 80% may be used. If a similarity score between two patterns exceeds the lower threshold but not the higher threshold, the pattern from the pattern library is identified as a similar pattern, and the new pattern is considered different enough to be added to the pattern library. If the similarity score exceeds the higher threshold, the pattern from the pattern library is identified as a similar pattern, but the new pattern is not added to the library. After identifying the similar patterns 113, the similarity calculator 108 passes the similar patterns 113 and the pattern 112 to the user interface 110.

At stage E, the user interface 110 displays the pattern 112 and the similar patterns 113. The user interface 110 displays the similarity scores for the similar patterns 113 and displays component/relationship mappings between each of the similar patterns 113 and the pattern 112. The user interface 110 also displays possible root causes or diagnoses based on data associated with each of the similar patterns 113. The user interface 110 can allow a user to iterate through the mappings and similarity scores for each of the similar patterns 113 and provide feedback on the usefulness of the mappings and similarity scores. For example, if a user identifies an incorrect or suboptimal component mapping, a process of the system in FIG. 1 may adjust the weights of a component or component attributes for the pattern in the pattern library 109 to improve future mappings and similarity score calculations. If the pattern 112 is to be added to the pattern library 109, the user interface 110 allows a user to prevent the addition of the pattern 112 or to modify components and relationships, add weights, add root cause analysis notes/data, etc., before adding the pattern 112 to the pattern library 109.

The above description of FIG. 1 describes the example process in relation to a single system graph 111. However, the system graph 111 is an evolving data structure that changes as components are added or removed from a system, additional events and performance metrics are received, additional anomalies occur, etc. As a result, the process described in FIG. 1 is repeated at various frequencies to continue monitoring and diagnosing anomalies experienced by the components 101. In some implementations, the generator 105 may pass a new system graph to the extractor 107 each time a new anomaly is detected. In other implementations, the generator 105 may pass a new system graph at predefined intervals, e.g. every two minutes. The system graph 111 may not include all events and metrics generated throughout the operation of the components 101. The generator 105 may be configured to keep the system graph 111 current for a given time period, such as the previous five minutes. In this way, the successively generated system graphs act as a snapshot for the system of the components 101.

FIG. 2 depicts an example pattern which may be stored in a pattern library. FIG. 2 depicts a pattern 201 that comprises nodes 205, 206, 207, and 208 (“the nodes”). The nodes are connected by edges indicating relationships between components represented by the nodes. Based on the relationships being represented, edges may be undirected, directed, bidirectional, and nodes may be connected by multiple edges. Node 206 is connected to node 205, for example, with a directional edge indicating that the node 206 submitted HTTP calls to the node 205. Nodes 207 and 208 are connected by an undirected edge to represent that the nodes share a power source. “Sharing” type relationships can be represented by undirected edges since sharing relationships are symmetric and, therefore, are not directional. As shown in FIG. 2, each of the nodes and the edges connecting the nodes are enriched with attribute and event data. The node 205, for example, has an attribute of “Type” with a value of “DataBase Master.” The edge between the nodes 205 and 206 has an attribute of “Type” with a value of “HttpCall” and event data of “callsPerInterval” with a value of “125441.” The nodes 206 and 208 each have an attribute of “HasAnomaly” set to a value of “true.” For instance, the nodes 206 and 208 may be considered to be experiencing anomalies because their “CPU” attributes have values over 50%. Even though the nodes 205 and 207 are not experiencing anomalies, they are included in the pattern 201 as these nodes may be relevant to diagnosing or determining a cause for the anomalies at nodes 206 and 208.

Although not depicted, each of the nodes and edges and their attributes in the pattern 201 may be assigned weights. For instance, since the nodes 206 and 208 represent nodes experiencing anomalies, the nodes 206 and 208 may be given an overall weight to emphasize the importance of mappings for those nodes and in determining similarity scores. Additionally, the attribute “CPU” for each of the nodes 206 and 208 may be assigned a weight since that attribute is an important factor of the anomaly.

The similarity between any of the nodes may be calculated based on determining a difference in their attribute values or using the function (6) above. When determining a similarity between the node 207 and the node 208, the first attribute “Type” may be compared and given a maximum similarity value of 1, for example, since the nodes have an identical value of “Web Application.” For the second attribute “CPU,” a difference in the values can be determined, e.g. 78−35=43, and indicate the similarity value as a percentage difference of 0.5513. The comparisons of attribute values may continue in this manner until an overall similarity score for the two nodes 207 and 208 is determined based on an average (possibly weighted average) of all the similarity values for the attributes. Some attributes, such as “Timestamp,” may not be compared or may be assigned a weight of 0 so that they do not affect an overall similarity score for the two nodes.

FIG. 3 depicts an example interface which displays a mapping between two patterns and allows for adjustment of node weights. FIG. 3 includes a pattern 301 and a pattern 302. Also depicted is an example similarity score 303 for the patterns 301 and 302. As indicated by the dashed lines, components of the pattern 301 are mapped to similar components of the pattern 302. For the sake of illustration, component types are represented by shapes of the nodes, e.g. the triangular node “worker” in pattern 301 is mapped to the triangular node “worker” in pattern 302. Although not depicted in the example mapping of FIG. 3, dashed lines may also be used to show mappings between edges of the patterns 301 and 302; however, the edge between the square and circle in pattern 301 cannot be mapped since no edge representing this relationship is present in pattern 302.

In FIG. 3, the pattern 301 is a new pattern generated for a system, and the pattern 302 is an old pattern stored in a pattern library. Pattern 302 includes a square node labeled “worker” which is larger than the other nodes of the pattern 302. The size of the square node is a graphical representation indicating that a larger weight value has been assigned to the square node. Through an interface such as the one in FIG. 3, a user may enlarge or shrink nodes to increase or decrease, respectively, weights associated with the nodes. The similarity score 303 may be updated in real time to reflect the effect of the modified weights on the similarity between the two patterns 301 and 302.

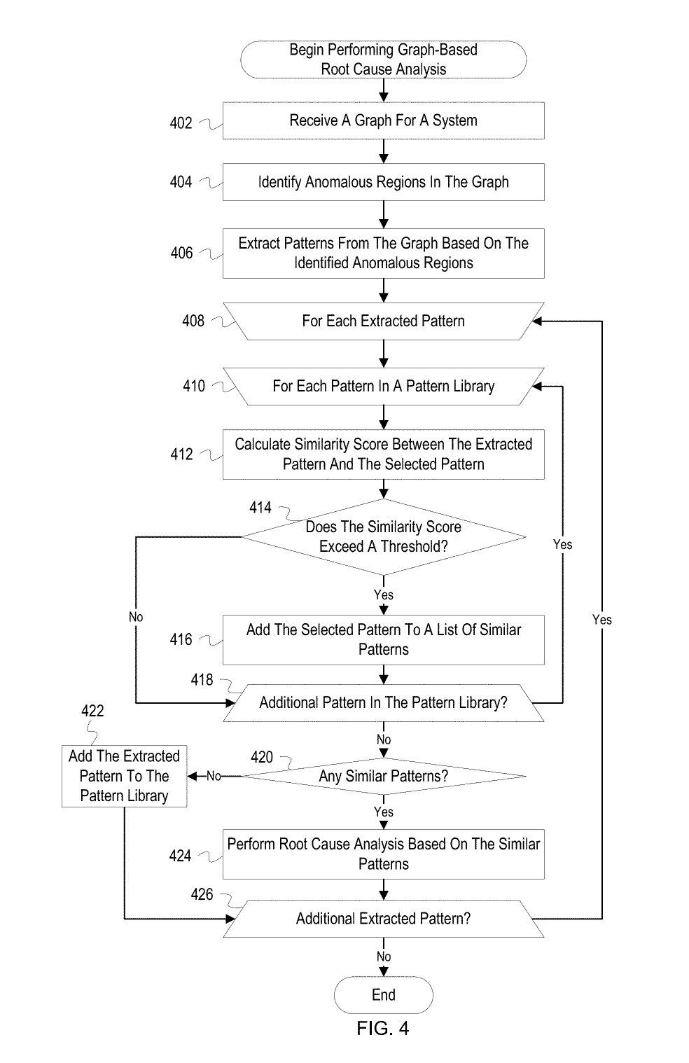

FIG. 4 depicts a flowchart with example operations for performing graph-based root cause analysis. FIG. 4 refers to a pattern analyzer as performing the operations even though identification of program code can vary by developer, language, platform, etc. The pattern analyzer may include software processes such as the extractor 107 and the similarity calculator 108 as described in FIG. 1.

A pattern analyzer (“analyzer”) receives a graph for a system (402). The graph for the system may have been generated based on event data and topology information for components in a network. Nodes and edges in the graph may include attribute information, such as types of components, types of relationships, identifiers, etc. The nodes and edges may also include or be linked to event data which indicate performance metrics or events at a component or between components. For example, the performance metrics may indicate memory usage or available storage space, and the events between component may indicate a number of invocations or an amount of transmitted data. The nodes and edges may be linked to event logs related to the represented components by including a file path to a log or a query for an event log database that returns related events. The graph may represent an overall state of the system or represent a snapshot of the system over a specified time period, such as the last ten minutes.

The analyzer identifies anomalous regions in the graph (404). The analyzer may traverse the graph or otherwise search the graph to identify nodes or edges which contain attribute values indicating that an anomalous event has occurred. The analyzer may access a rules or policies database which indicates various thresholds and conditions that, if satisfied, indicate that an anomaly is occurring. The analyzer determines whether attribute or event data for the nodes and edges in the graph satisfy conditions in the applicable rules. For example, a rule may indicate that if a component is exceeding a specified amount of bandwidth consumption then the component is experiencing an anomaly. The analyzer can identify applicable rules for each node and edge of the graph by determining a component/relationship type and retrieving a rule for the component/relationship type. The analyzer may flag nodes/edges indicating an anomaly by adding coordinates or other identifiers for the node/edges to a list or enriching the nodes/edges with attribute data indicating that an anomaly is occurring.

The analyzer extracts patterns from the graph based on the identified anomalous regions (406). A pattern is a sub-graph of the overall system graph that represents an anomalous region of the system. The pattern contains nodes, edges, and data relevant to an anomaly experienced at one or more components. The analyzer can identify and extract patterns for anomalous regions by determining which elements of the graph (i.e., nodes and edges) are experiencing anomalies and identifying elements related to the anomalous elements. The extracted patterns should include elements representing components experiencing the anomalies, contributing to the anomalies, affected by the anomalies, or likely to be affected by the anomalies. The analyzer can identify related, non-anomalous elements to include in a pattern based on whether the elements are located near an anomalous element(s) in the graph (e.g., less than three edges of separation from an anomalous node), are part of a same sub-system, or are of a same type of component/relationship as the anomalous element(s). Once the analyzer has identified anomalous regions, the analyzer creates the patterns by extracting the nodes and edges from the overall system graph for each of the anomalous regions. The analyzer may also add additional data to the patterns not found in the system graph. For example, the analyzer may identify relevant rules, conditions, or thresholds which were used to identify the anomalous components. The analyzer may also retrieve additional event logs or performance metrics from a database to be associated with one or more of the patterns.

The analyzer begins root cause analysis operations for each extracted pattern (408). The analyzer may iterate through the patterns based on a size of each extracted pattern, a severity of anomalies indicated in the patterns, etc. For example, the analyzer may begin with patterns which include several anomalies such as a server or disk failure. The extracted pattern for which the analyzer is currently performing operations is hereinafter referred to as “the extracted pattern.”

The analyzer begins comparing the extracted pattern to each pattern in a pattern library (410). The analyzer may iterate through each pattern in the pattern library and perform the operations as described below. In some implementations, the analyzer may limit the comparisons to patterns in the pattern library which include a same anomaly as the extracted pattern, include same/similar component or relationship types, include a same/similar number of components, etc. For example, if the extracted pattern includes components for a database system, the analyzer may only perform the below operations for patterns in the pattern library that also include a database system. Additionally, the analyzer may not compare the patterns sequentially or in a loop but may instead utilize metadata, such as indexes, or other searching techniques/algorithms to identify similar patterns in the pattern library in a manner more efficient than O(n) time. The pattern from the pattern library for which the analyzer is currently performing operations is hereinafter referred to as “the selected pattern.”

The analyzer calculates a similarity score between the extracted pattern and the selected pattern (412). In general, the analyzer determines a similarity score by mapping nodes/edges in the extracted pattern to nodes/edges in the selected pattern and then determining a similarity between each of the mapped elements. The similarities between the mapped elements are then be accumulated into an overall similarity score representative of a similarity between the two patterns. The similarities between the elements can be based on a similarity of attribute values, events in event logs, relationships of the components, weights added to the elements or attributes, etc. As described in more detail below, the similarity score can be calculated using a modified A* algorithm or other informed search algorithm or best-first search algorithm. As a brief summary, the A* algorithm solves the similarity problem by exploring a space of possible mappings for each element in the extracted pattern to the selected pattern and selecting a most promising mapping until the algorithm can guarantee that the mapping which incurs the smallest cost (i.e., is the most similar) has been found. The cost for each mapping are aggregated into an overall cost or similarity score. The similarity score may be normalized based on a number of elements in the selected pattern. If the extracted pattern has a larger number of elements than the selected pattern, then a number of elements in the extracted pattern will not be mapped to the extracted pattern, leading to a reduced similarity score for the two patterns. To eliminate the effect of pattern size on the similarity score, the selected pattern may be associated with a normalization value which is determined based on a comparison of the number of elements in the selected pattern to a number of elements in other patterns of the pattern library. The larger the number of elements in relation to the other patterns the more the calculated similarity score will be reduced for the selected pattern. Conversely, the fewer the relative number of elements the more the similarity score will be increased.

The analyzer determines whether the similarity score exceeds a threshold (414). The analyzer first determines an applicable threshold for the extracted pattern. The threshold may be the same for all patterns or may vary based on a component, anomaly, or sub-system type represented in the extracted pattern. After determining the threshold, the analyzer compares the similarity score to the threshold (e.g., compares a threshold of 0.75 to a similarity score of 0.81). If the similarity score is greater than or equal to the threshold, the analyzer determines that the similarity score exceeds the threshold. If the similarity score is less than the threshold, the analyzer determines that the similarity score does not exceed the threshold.

If the analyzer determines that the similarity score exceeds the threshold, the analyzer adds the selected pattern to a list of similar patterns (416). The analyzer may retrieve the selected pattern and any associated data from the pattern library or add an identifier for the pattern to a list of patterns which have been determined as sufficiently similar to the extracted pattern.

If the analyzer determines that the similarity score does not exceed the threshold or after adding the selected pattern to the list of similar patterns, the analyzer determines whether there is an additional pattern in the pattern library (416). If there is an additional pattern in the pattern library, the analyzer selects the next pattern from the library (410). In some implementations, the analyzer selects a next pattern using index structures which aid in the retrieval of patterns which are likely to be similar to the extracted pattern.

If there is not an additional pattern in the pattern library, the analyzer determines whether any similar patterns were added to the list for the extracted pattern (420). If the list contains a similar pattern, this indicates that at least one pattern in the pattern library was found which was sufficiently similar to the extracted pattern and can be used for root cause analysis. If the list does not contain any patterns, this indicates that no patterns in the pattern library exceeded the similarity score threshold.

If no similar patterns were identified, the analyzer adds the extracted pattern to the pattern library (422). Since no similar patterns were identified, the analyzer determines that the extracted pattern is unique and should be added to the pattern library. Prior to adding the extracted pattern to the pattern library, the analyzer may display the extracted pattern in a user interface to allow for diagnosis notes, weights, event logs, etc., to be added to the extracted pattern. The analyzer may also allow a user to prevent the pattern from being added to the library. By adding unique patterns to the pattern library, the pattern library becomes more useful over time by containing more potential solutions to anomalies. In some implementations, the pattern library may be given an initial set of patterns that were derived from a similar system as a starting point for the root cause analysis system.

If similar patterns were identified, the analyzer performs root cause analysis for the anomalies in the extracted pattern based on the similar patterns identified in the pattern library (422). The analyzer may retrieve any diagnosis notes or solutions associated with each of the similar patterns from the pattern library and display the solutions for a user. The analyzer may also display the mappings of elements and similarity scores for each of the similar patterns to the extracted pattern. A user may interact with the displayed mappings by approving or rejecting mappings, changing mappings, adjusting weights for elements/attributes, etc. In some instances, the patterns in the pattern library may be associated with scripts which perform commands to solve anomalies. For example, if a previous anomaly in a pattern was solved by restarting a server, the pattern may be associated with a script which when executed causing a server to be restarted or power cycled. If a most similar pattern is associated with a script, the analyzer may modify the script based on an anomalous component in the extracted pattern (e.g. add an identifier or IP address for the component to the script) and automatically execute the commands in the script. The analyzer can then monitor events to determine whether the anomaly was solved and display to a user which actions were taken.

After adding the extracted pattern to the library or after performing root cause analysis based on the similar patterns, the analyzer determines whether there is an additional extracted pattern (426). If there is an additional extracted pattern, the analyzer selects the next extracted pattern (408). If there is not an additional extracted pattern, the process ends.

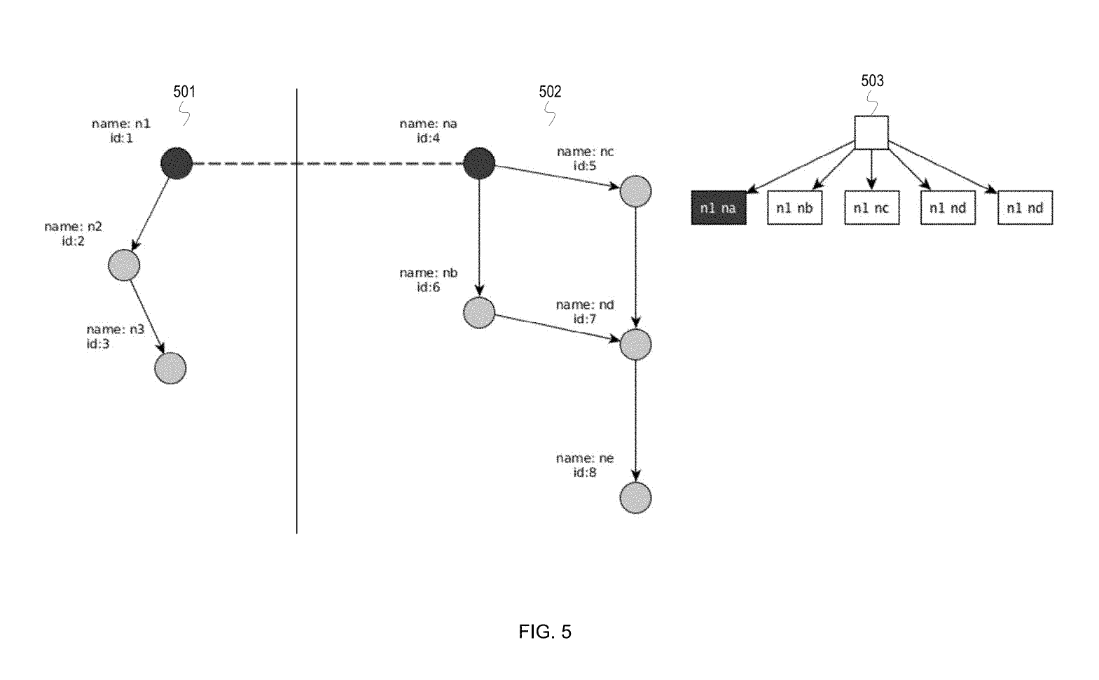

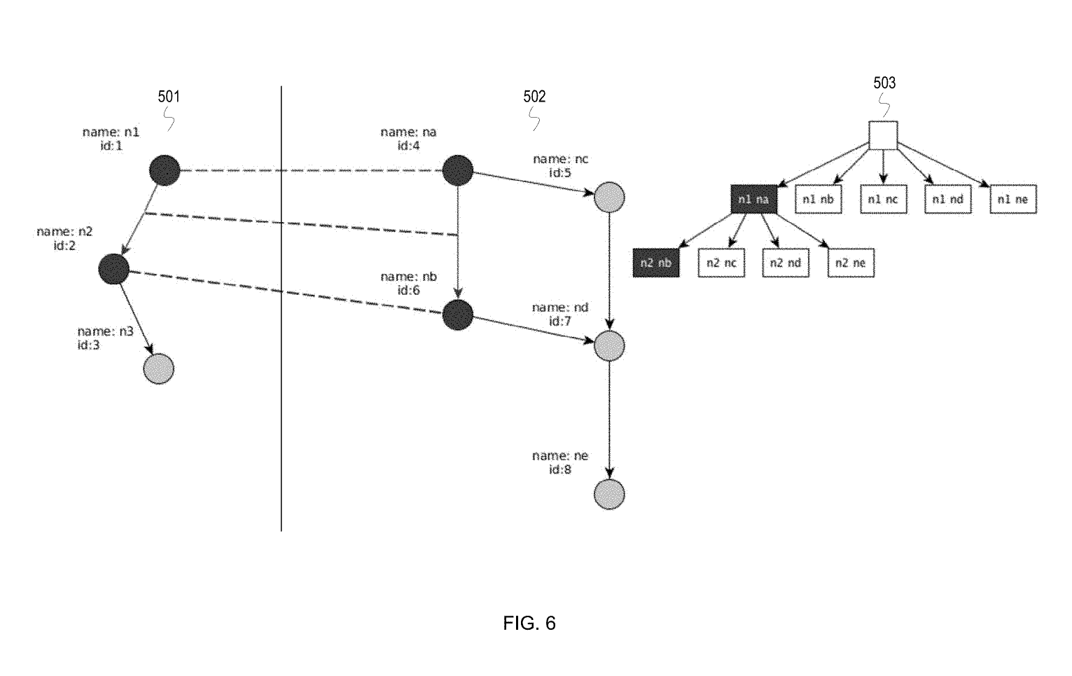

FIGS. 5 and 6 depict an example mapping of elements between a pair of patterns. The mapping may be performed as part of calculating a similarity score, such as the calculation performed by the similarity calculator 108. FIGS. 5 and 6 depict a pattern 501 which represents components currently experiencing an anomaly in a system and a pattern 502 which is part of a pattern library and represents components which previously experienced an anomaly. Pattern 501 includes nodes with names n1, n2, and n3, and pattern 502 includes nodes with names na, nb, nc, nd, and ne. FIGS. 5 and 6 also depict an expansion 503 which graphically represents the progression of a best-first search algorithm, such as the A* algorithm.

The A* algorithm solves problems by searching among possible paths to the solution (goal) for the path that incurs the smallest cost. Among the possible paths, the algorithm first considers the paths that appear to lead most quickly to the solution, i.e. paths that have the lowest cost, and discards paths which are unlikely to represent an optimal solution. The resulting solution is the path that minimizes the cost function:

f(n)=g(n)+h(n) (7)

### Where:

f(n) is the cost of expanding the search path by a node n
g(n) is the accumulated cost of a certain path until the node n is reached
h(n) is a heuristic that approximates the minimum cost of the path from n to the solution

The function g(n) can be further defined by the function:

g(n)=g_{acc}(n)+(1−sim(e_{g1},e_{g2})) (8)

This function determines the accumulated cost of the expanded paths (g_{acc}(n)) and adds the complement of the similarity between mapped elements of the graphs sim(e_{g1}, e_{g2}). In the present application of the A* algorithm, the heuristic function h(n) is an under-approximation of the remaining cost of the unmapped elements. For each mapping of nodes between two patterns, a difference in the degrees (i.e., the number of edges) for two mapped nodes indicates a cost that will be incurred as a result of at least some of the edges not being mapped. The h(n) minimum cost for the path can be determined based on the minimum weights of the one or more edges which cannot be mapped. Similarly, if two patterns have different numbers of nodes, then there is a minimum number of nodes which will not be mapped. At any stage during execution of the algorithm, the h(n) minimum cost can be determined based on calculating, for each node in the smaller pattern, the minimum cost of mapping with any of the remaining nodes of the larger pattern, taking node weights into account. At the end of the algorithm process, the similarity score for two patterns can be determined based on a complement of the summation of the costs calculated for each mapping. For example, the similarity score is equal to 1 minus the sum of f(n) for each mapped element. In some implementations, the similarity score for patterns may be further decreased by a constant for each graph element for which a mapping was not found.

In FIG. 5, as indicated by the dashed line, the node n1 of the pattern 501 has been mapped to the node na of the pattern 502. As shown in the expansion 503, the algorithm considered possible mappings of the node n1 to nodes in the pattern 502. In some instances, the algorithm can eliminate nodes whose selection are unlikely to lead to an optimal solution, e.g. nodes whose cost exceed h(n). The mappings include (n1, na), (n1, nb), (n1, nc), (n1, nd), and (n1, ne). The algorithm selected the mapping (n1, na) based on the mapping minimizing the function f(n). In general, the algorithm selects the mapping between nodes which are the most similar, so it can be presumed that the node n1 is more similar to the node na than any other node in the pattern 502. The algorithm may determine a similarity score for each possible mapping of elements using the function (6) shown above. After mapping the node n1, the algorithm may select the node n2 of the pattern 501 for mapping.

In FIG. 6, the node n2 of the pattern 501 has been mapped to the node nb of the pattern 502. As shown in the expansion 503, the algorithm considered all possible mappings of the node n2 to the remaining nodes in the pattern 502: (n2, nb), (n2, nc), (n2, nd), and (n2, ne). The algorithm selected the mapping (n2, nb) based on the mapping minimizing the function f(n). After mapping the node n2, the algorithm determines that there is an edge between the two mapped nodes n1 and n2 in the pattern 502 and maps the edge to a corresponding edge between the nodes na and nb in the pattern 502. If a corresponding edge did not exist in the pattern 502, then the edge between the nodes n1 and n2 in the pattern 501 would not be mapped, leading to a penalty in the similarity score.

Mapping of the remaining elements in the pattern 501 continues in a similar manner as described above. As the elements between the patterns 501 and 502 are being mapped, a cost of the overall solution is updated. Once all elements which can be mapped have been mapped, a final similarity score is determined.

The above process can be improved by determining an order of elements to follow when attempting to map nodes from the pattern 501 to the pattern 502. The order may be based on topological features of nodes, component types, attribute types, which nodes are experiencing an anomaly, etc. For example, based on topological features, a node mapping order could consider the connections of nodes so that every pair of nodes that have an edge in common are computed in sequence. This allows for easier mapping of common edges as shown in FIG. 6.

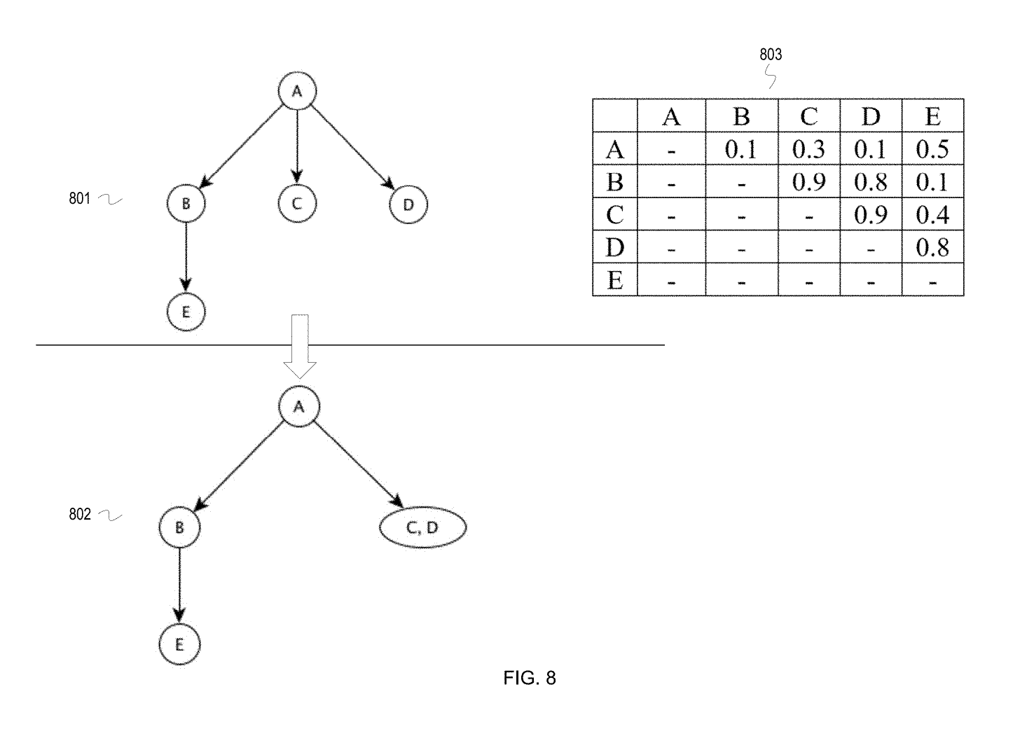

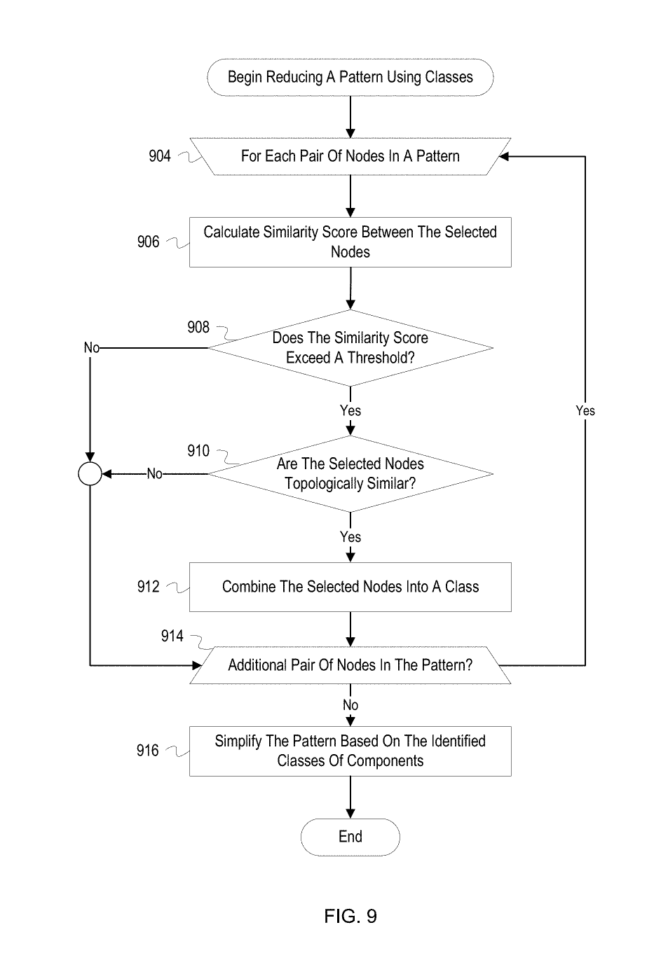

The patterns 501 and 502 in FIGS. 5 and 6 are simple patterns to allow for ease of explanation. As systems grow in complexity, patterns may comprise tens or hundreds of nodes leading to an exponential increase in the expansions or number of possible paths to a solution. As a result, reducing the search space (i.e., reducing the number of possible paths) can reduce the computational time and provide greater scalability for graph-based root cause analysis. Techniques for simplifying the patterns to reduce the search space are described in FIGS. 8 and 9.

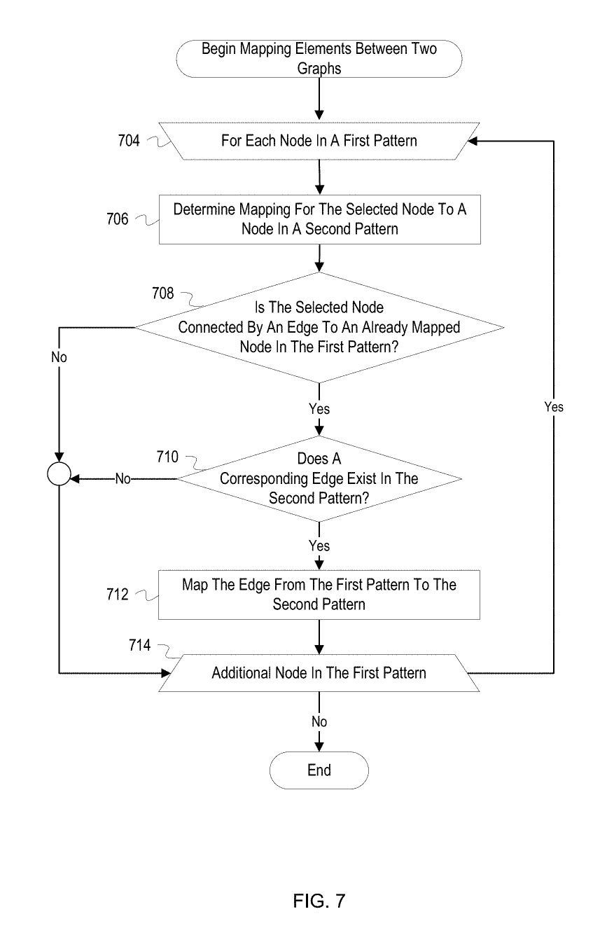

FIG. 7 depicts a flowchart with example operations for mapping elements between two graphs. FIG. 7 refers to a pattern analyzer as performing the operations even though identification of program code can vary by developer, language, platform, etc. The pattern analyzer may include software processes such as the extractor 107 and the similarity calculator 108 as described in FIG. 1.

A pattern analyzer (“analyzer”) begins operations for mapping elements in a first pattern to elements in a second pattern (704). The analyzer iterates over nodes in the first pattern and determines a mapping for each node. In some implementations, the analyzer may utilize various heuristics to determine an ordering for which the nodes in the first pattern should be mapped. In some implementations, the analyzer may precompute similarity scores between nodes of the first pattern and nodes of the second pattern. The node of the first pattern which has a highest similarity score to a node in the second pattern may be selected for mapping first. The mapping of the nodes may continue in order of descending similarity scores, or the ordering may be determined based on which nodes are connected to the highest similarity score node by the most edges and may continue in a similar manner throughout the rest of the nodes. In other implementations, nodes may be ordered based on degrees of the nodes (i.e., number of edges connected to the nodes) from largest degree to lowest degree. Ties between the nodes in degrees or similarity scores may be settled based on random selection or other parameters, such as component type or degree. The node in the first pattern for which operations are currently being performed is hereinafter referred to as the selected node.

The analyzer determines a mapping for the selected node to a node in the second pattern (706). The analyzer determines the mapping using an algorithm, such as the A* algorithm as described above. In general, the analyzer maps the selected node to a most similar node in the second pattern. However, in order to allow for the best possible solution, the mapping may not always be to the most similar node. For example, a mapping between the most similar nodes may force other nodes to be mapped to very dissimilar nodes, ultimately leading to a higher cost for the solution. After determining the mapping, the analyzer may add the mapping to a list of mappings for elements in the first pattern to elements in the second pattern. Conversely, if the analyzer was unable to map the selected node, e.g. in cases where the second pattern has no more available nodes or no sufficiently similar nodes, the analyzer may add the selected node to a list of unmapped elements for the first pattern. Although not indicated in FIG. 7, if the analyzer is unable to map the selected node, the analyzer selects a next node from the first pattern if any nodes are remaining (704).

The analyzer determines whether the selected is connected by an edge to an already mapped node in the first pattern (708). If two mapped nodes in the first pattern are connected by an edge, the analyzer can attempt to map the edge to an edge element in the second pattern. The analyzer may determine all nodes connected by an edge to the selected node and determine if any of the nodes have been mapped by consulting the list of mapped elements. If any of the nodes have been mapped, the analyzer determines that the selected node is connected by an edge to an already mapped node. If none of the connected nodes have been mapped, the analyzer determines that an attempt to map edges of the selected node should not currently be performed.

If the selected node is connected by an edge to an already mapped node, the analyzer determines whether a corresponding edge exists in the second pattern (710). A corresponding edge exists if an edge exists between the two corresponding mapped nodes in the second pattern. For example, if node A1 is mapped to node B1 and node A2 is mapped to B2, an edge between the nodes A1 and A2 exists in the second pattern if there is an edge between the nodes B1 and B2. The analyzer may consider directionality or relationship type of the edges to determine whether the edges actually correspond to one another. For example, if the edges have differing directionality, the analyzer may determine that the edges do not correspond to each other and ultimately should not be mapped.

If a corresponding edge exists in the second pattern, the analyzer maps the edge from the first pattern to the second pattern (712). Similar to the node mapping, the analyzer may add the mapping of the edges to a list of mapped elements for the first pattern to the second pattern.

After mapping the edge or after determining at either block 708 or 710 that an edge cannot be mapped, the analyzer determines whether there is an additional node in the first pattern (712). If there is an additional node in the first pattern, the analyzer selects the next node (704). As described above, the analyzer may utilize a heuristic to determine the next node to be selected for mapping.

If there is not an additional node in the first pattern, the process ends. The result of the above operations is a data structure indicating mappings between elements in the first graph and elements in the second graph. The data structure may be loaded in a mapping function such as the mapping function m(x) described in relation to function (5) above.

FIG. 8 depicts an example of combining equivalent nodes into a single representative node to reduce an algorithmic search space. FIG. 8 depicts a pattern 801, a pattern 802, and a node similarity matrix 803. The pattern 801 may be a pattern in a pattern library or a recently extracted pattern representing a current system anomaly. The pattern 802 is the pattern 801 after equivalent nodes C and D have been combined into a single node to represent the class of nodes.

Two nodes are considered to be equivalent or as belonging to a same class of nodes if the nodes are similar in terms of a similarity score and topological features. For a given pattern, such as the pattern 801, similarity scores can be calculated between each unique pair of nodes in a pattern. As shown in the similarity matrix 803, ten similarity scores have been calculated based on each possible combination of nodes in the pattern 801, e.g., (A, B), (A, C), (A, D), (A, E), etc. For example, the similarity score for the node pair A and B is 0.1. The similarity score for the nodes may be calculated using a function similar to the function (6). In general, the similarity between nodes is based on a similarity of attribute values, such as component type, subnet address, sub-system identifier, etc., and also considers similarity of assigned weights to the node and its attributes. If the similarity score for a node pair exceeds a threshold, the nodes can be considered for combination into a class. In FIG. 8, the node pairs (B, C), (B, D), (C, D), and (D, E) each have a similarity score of 0.8 or higher and may be considered for combination. Additionally, the node pairs (B, C), (B, D), and (C, D) have overlapping elements, i.e. all three of the nodes are similar to each other. As a result, all three nodes (B, C, and D) may be considered as a class of nodes to be combined into a single node. The node E, however, is only considered for combination with the node D, since the node E, unlike the node D, does not have overlapping similarity to nodes B and C

When determining whether to combine the nodes, the topological features of the nodes are also considered. The topological features considered can include a number of and directionality of edges or relationships to other nodes and identities of the connected nodes, i.e. whether the nodes are structurally equivalent. Other topological features may be analyzed such as whether nodes have an automorphic equivalence (i.e., whether nodes can be swapped without affecting graph distances) and hierarchical equivalence (i.e., graph distance from a parent node). In the pattern 801, the node B is topologically different from nodes C and D since the node B has two connections: one to node A and one to node E. The nodes E and D are also topologically different because the node E is connected to the node B, while the node D is connected to the node A. Nodes C and D, however, are topologically similar because both nodes are only connected to the node A.

Since the nodes C and D have a high similarity score and are topologically similar, the nodes C and D can be combined into a single class. As shown in the pattern 802, a single node is now used to represent both the nodes C and D. During execution of a mapping algorithm as described above, the combined node C, D in the pattern 802 can be treated as a single node when mapping to a node in another pattern. For example, a node representing a class of nodes can be mapped in a manner similar to that described for a node in the flowchart of FIG. 7. When mapping the node C, D to potential mapping nodes, the attributes of the node C, the node D, or an average of attributes from both nodes may be used to calculate similarities with the potential mapping nodes. When mapping a class of nodes to another class of nodes, once the classes have been determined to be similar or nodes from each of the classes have been determined to be similar, nodes within the classes can be automatically mapped to one another. For example, if a class includes nodes A, B and a similar class includes nodes X, Y, Z, the node A may be mapped to node X, and the node B may be mapped to node Y without additional calculation of similarity scores. In this example, since the classes contain a different number of nodes, the node Z remains unmapped and can be removed from its existing class and placed into a singleton class. Since the node Z is unmapped, the node Z can cause a reduction in similarity scores. In some implementations, nodes representing a class of components may be mapped without further mapping of the nodes within the classes. In such implementations, the difference in number of nodes for the classes does not affect the similarity score, as the class nodes are treated as if they were single components. Additionally, a class of nodes in a first pattern may be mapped to a single, non-class node in a second pattern, or vice versa.

Combining or grouping equivalent nodes as described above can be used to simplify and reduce patterns stored in a pattern library or on extracted patterns representing a current system state. When comparing two patterns which each have nodes representing classes of nodes, the class nodes can be mapped as normal nodes even if the class nodes represent differing numbers of components. For example, a class node in a first pattern may represent three servers while a class node in a second pattern may represent ten servers. These two class nodes can be mapped to each other, even though the class node in the second pattern represents more servers. However, during the mapping process or after a similarity score has been calculated, adjustments can be made for a differing number of components represented by class nodes. For example, a similarity between class nodes computed during the mapping process may be adjusted based on a percentage difference between the number of components represented. Likewise, a final similarity score can be adjusted if a class node in one pattern represents more or fewer components than another class node.

Representing multiple components/nodes in a class node allows the algorithm to perform more quickly by reducing an overhead in the expansion of the possible paths. Because nodes are combined, the search space is reduced and, therefore, the computing cost of the mapping and the similarity score calculation for two patterns is also reduced.

FIG. 9 depicts a flowchart with example operations for reducing a pattern using classes. FIG. 9 refers to a pattern analyzer as performing the operations even though identification of program code can vary by developer, language, platform, etc. The pattern analyzer may include software processes such as the extractor 107 and the similarity calculator 108 as described in FIG. 1.

A pattern analyzer (“analyzer”) begins operations for each pair of nodes in a pattern (904). The pattern may be part of a pattern library or may be a pattern recently extracted from a system graph. The analyzer performs operations for each unique pair of nodes in the pattern. For example, for a pattern with nodes A, B, and C, the analyzer performs operations for node pairs (A, B), (A, C), and (B, C). The two nodes in a pair for which the analyzer is currently performing operations is hereinafter referred to as “the selected nodes.”

The analyzer calculates a similarity score between the selected nodes (906). The analyzer may calculate the similarity score using the function (6) described above. In general, the similarity score is based on a similarity of attribute values and assigned weights for the selected nodes. After calculating the similarity score, the analyzer may insert the similarity score at a location in a matrix which corresponds to the selected node pair.

The analyzer determines whether the similarity score exceeds a threshold (908). The analyzer compares the similarity score to a threshold which controls whether the selected nodes are sufficiently similar to be combined into a class. For example, the analyzer may determine whether the similarity score is greater than 0.9. Even if the similarity score exceeds threshold, other factors may prevent the selected nodes from being deemed sufficiently similar. For example, if the select nodes represent different component types (e.g., a web server and a database), the analyzer determines that the selected nodes are not sufficiently similar and should not be combined into a class, regardless of the similarity score.

If the similarity score exceeds the threshold, the analyzer determines whether the selected nodes are topologically similar (910). The topological features considered can include a number of and directionality of edges to other nodes and identities of the connected nodes. The analyzer may also consider locations of the selected nodes within the pattern. If the selected nodes are more than a specified distance apart, e.g. more than four edges away from each other, the analyzer may determine that the selected nodes are not topologically similar. Additionally, the analyzer can consider relationship types and attributes of the edges for the selected nodes. If both of the selected nodes are connected to a parent node, the selected nodes may not be topologically similar if the selected nodes each have a different relationship type with the parent node.

If the selected nodes are topologically similar, the analyzer combines the selected nodes into a class (912). Since the selected nodes have a sufficient similarity score and are topologically similar, the analyzer determines that the selected nodes can be combined into a class and represented by a single node in the pattern. Before combining the selected nodes, the analyzer determines whether either of the selected nodes already belongs to a class. If one of the selected nodes already belongs to a class, the other selected node may be added to the same class. Prior to adding the other node to the existing class, the analyzer may verify that the other node is also sufficiently similar to existing members of the class.

After combining the selected nodes into a class or after determining at block 908 or 910 that the selected nodes are not sufficiently similar, the analyzer determines whether there is an additional pair of nodes in the pattern (914). If there is an additional pair of nodes, the analyzer selects the next pair of nodes (904).

If there is not an additional pair of nodes in the pattern, the analyzer simplifies the pattern based on the identified classes of nodes (916). The analyzer modifies the pattern by adding nodes to represent the determined classes of nodes and removing nodes which are members of the determined classes. A node added to represent a class is located in the pattern and is connected with edges to other nodes so as to be topologically similar to the member nodes of the class. After simplifying the pattern, the analyzer may store the simplified pattern in the pattern library or, if the pattern represents a current anomalous region in a system, may begin graph-based root cause analysis using the simplified pattern.

Variations

FIG. 1 is annotated with a series of letters A-E. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 404 and 406 of FIG. 4 can be performed in parallel or concurrently. Also with respect to FIG. 4, block 422 is not necessary. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

The above description refers to the use of thresholds to determine whether parameters are within or outside of prescribed operating conditions. In some instances, a threshold is satisfied if an attribute value or performance metric exceeds or is greater than the threshold, such as bandwidth consumption metric being greater than a bandwidth consumption threshold. In other instances, a threshold is satisfied if an attribute value or performance metric falls below or is less than the threshold, such as an available memory metric being less than an available memory threshold.

Some operations above iterate through sets of items, such as patterns or elements in a graph or pattern. In some implementations, these items may be iterated over according to an ordering of items, an indication of item importance, an item timestamp, etc. Also, the number of iterations for loop operations may vary. Different techniques for performing graph-based root cause analysis or mapping/reducing graph elements may require fewer iterations or more iterations. For example, metadata or index structures may be used to reduce the number patterns to be compared. For example, some elements may be ignored or disregarded based on a represented component type or attribute value. Specifically, in regard to the operations beginning at block 410 of FIG. 4, various or algorithms or search techniques may be used to reduce the number of patterns to be compared. Additionally, the operations at block 410 may only continue until a threshold number of similar patterns have been identified. In some implementations, the pattern analyzer may group the patterns in the pattern library into classes based on determined similarities between the patterns or based on component types or anomaly types represented in the patterns. For example, two or more patterns which have a high calculated similarity score among each other may be grouped into a class. The pattern analyzer may then compare an extracted pattern to only a single pattern from each class until a similar pattern is identified. The pattern analyzer may then continue comparing the extracted pattern to other patterns in the identified class.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

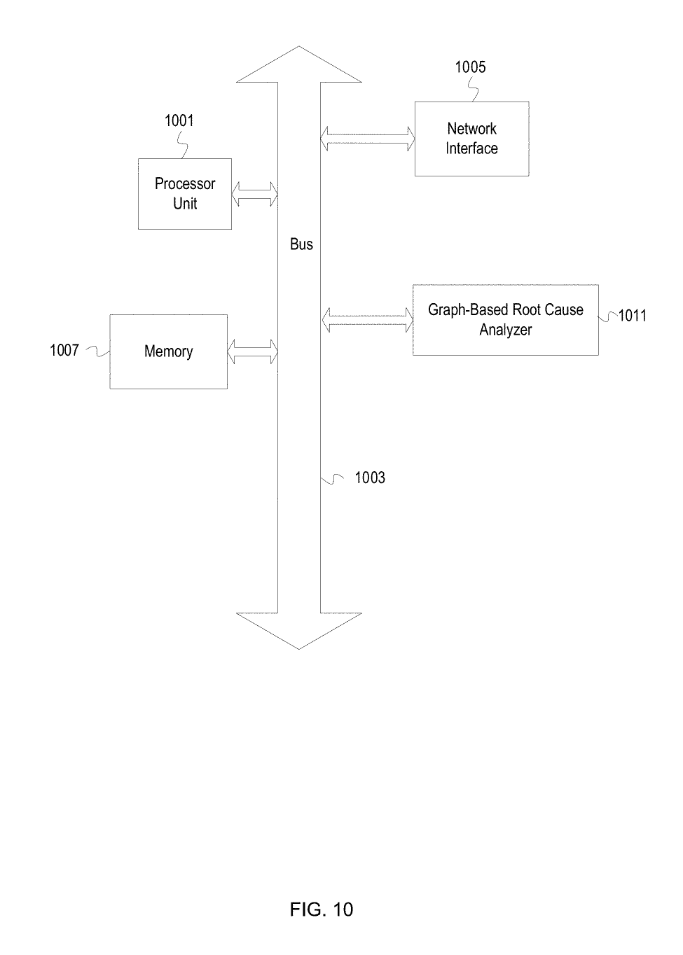

FIG. 10 depicts an example computer system with a graph-based root cause analyzer. The computer system includes a processor unit 1001 (possibly including multiple processors, multiple cores, multiple nodes, and/or implementing multi-threading, etc.). The computer system includes memory 1007. The memory 1007 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 1003 (e.g., PCI, ISA, PCI-Express, HyperTransport® bus, InfiniBand® bus, NuBus, etc.) and a network interface 1005 (e.g., a Fiber Channel interface, an Ethernet interface, an internet small computer system interface, SONET interface, wireless interface, etc.). The system also includes a graph-based root cause analyzer 1011. The graph-based root cause analyzer 1011 performs root cause analysis of current system anomalies through efficient identification of similar patterns/graphs representing historical system anomalies. Any one of the previously described functionalities may be partially (or entirely) implemented in hardware and/or on the processor unit 1001. For example, the functionality may be implemented with an application specific integrated circuit, in logic implemented in the processor unit 1001, in a co-processor on a peripheral device or card, etc. Further, realizations may include fewer or additional components not illustrated in FIG. 10 (e.g., video cards, audio cards, additional network interfaces, peripheral devices, etc.). The processor unit 1001 and the network interface 1005 are coupled to the bus 1003. Although illustrated as being coupled to the bus 1003, the memory 1007 may be coupled to the processor unit 1001.

While the aspects of the disclosure are described with reference to various implementations and exploitations, it will be understood that these aspects are illustrative and that the scope of the claims is not limited to them. In general, techniques for graph-based root cause analysis as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
based on a first system graph, identifying a first component represented in the first system graph which is experiencing a first anomaly;
extracting a first pattern from the first system graph which comprises the first component, wherein the first pattern comprises a sub-graph of the first system graph;
identifying a set of historical patterns which are similar to the first pattern based, at least in part, on comparing the first pattern to a plurality of historical patterns; and
performing root cause analysis of the first anomaly based, at least in part, on diagnostic data associated with the set of historical patterns.

2. The method of claim 1, wherein identifying the set of historical patterns which are similar to the first pattern based, at least in part, on comparing the first pattern to the plurality of historical patterns comprises determining a similarity score for at least a first historical pattern of the plurality of historical patterns in relation to the first pattern.

3. The method of claim 2, wherein determining the similarity score for the first historical pattern in relation to the first pattern comprises:
mapping a first element of the first pattern to a most similar element in the first historical pattern; and
determining the similarity score based, at least in part, on a similarity between the first element and the most similar element.

4. The method of claim 3, wherein mapping the first element of the first pattern to the most similar element in the first historical pattern comprises:
comparing a first attribute value of the first element to attribute values of elements in the first historical pattern; and
identifying the most similar element from the elements in the first historical pattern based, at least in part, on the most similar element having an attribute value closest to the first attribute value.

5. The method of claim 1 further comprising, based on a determination that none of the plurality of historical patterns satisfy a similarity threshold, adding the first pattern to the plurality of historical patterns.

6. The method of claim 1, wherein identifying the first component represented in the first system graph which is experiencing the first anomaly comprises:
retrieving thresholds for performance metrics associated with the first component;
comparing the performance metrics to the thresholds; and
based on a determination that any of the performance metrics satisfy the thresholds, determining that the first component is experiencing an anomaly.

7. The method of claim 1 further comprising:
identifying a second component represented in the first system graph that is experiencing a second anomaly; and
based on a determination that the first anomaly and the second anomaly are related, adding a region of the first system graph which comprises the second component to the first pattern.

8. The method of claim 1, wherein extracting the first pattern from the first system graph which comprises the first component comprises extracting a node representing the first component from the first system graph and extracting at least one of nodes within a threshold distance of the node representing the first component and nodes within a same subsystem as the first component.

9. The method of claim 1, wherein the plurality of historical patterns comprises extracted patterns representing anomalous components previously encountered in a system.

10. One or more non-transitory machine-readable media comprising program code, the program code to:
based on a first system graph, identify a first component represented in the first system graph which is experiencing a first anomaly;
extract a first pattern from the first system graph which comprises the first component, wherein the first pattern is a sub-graph of the first system graph;
identify a set of a plurality of historical patterns which are similar to the first pattern based, at least in part, on comparing the first pattern to the plurality of historical patterns; and
perform root cause analysis of the first anomaly based, at least in part, on diagnostic data associated with the set of historical patterns.

11. The machine-readable media of claim 10, wherein the program code to identify the set of historical patterns which are similar to the first pattern based, at least in part, on comparing the first pattern to the plurality of historical patterns comprises program code to determine a similarity score for at least a first historical pattern of the plurality of historical patterns in relation to the first pattern.

12. An apparatus comprising:
a processor; and
a machine-readable medium having program code executable by the processor to cause the apparatus to,
based on a first system graph, identify a first component represented in the first system graph which is experiencing a first anomaly;
extract a first pattern from the first system graph which comprises the first component, wherein the first pattern is a sub-graph of the first system graph;
identify a set of a plurality of historical patterns which are similar to the first pattern based, at least in part, on comparing the first pattern to the plurality of historical patterns; and
perform root cause analysis of the first anomaly based, at least in part, on diagnostic data associated with the set of historical patterns.

13. The apparatus of claim 12, wherein the program code to identify the set of historical patterns which are similar to the first pattern based, at least in part, on comparing the first pattern to the plurality of historical patterns comprises program code to determine a similarity score for at least a first historical pattern of the plurality of historical patterns in relation to the first pattern.

14. The apparatus of claim 13, wherein the program code to determine the similarity score for the first historical pattern in relation to the first pattern comprises program code to:
map a first element of the first pattern to a most similar element in the first historical pattern; and
determine the similarity score based, at least in part, on a similarity between the first element and the most similar element.

15. The apparatus of claim 14, wherein the program code to map the first element of the first pattern to the most similar element in the first historical pattern comprises program code to:
compare a first attribute value of the first element to attribute values of elements in the first historical pattern; and
identify the most similar element from the elements in the first historical pattern based, at least in part, on the most similar element having an attribute value closest to the first attribute value.

16. The apparatus of claim 12 further comprising program code to, based on a determination that none of the plurality of historical patterns satisfy a similarity threshold, add the first pattern to the plurality of historical patterns.

17. The apparatus of claim 12, wherein the program code to identify the first component represented in the first system graph which is experiencing the first anomaly comprises program code to:
retrieve thresholds for performance metrics associated with the first component;
compare the performance metrics to the thresholds; and
based on a determination that any of the performance metrics satisfy the thresholds, determine that the first component is experiencing an anomaly.

18. The apparatus of claim 12 further comprising program code to:
identify a second component represented in the first system graph that is experiencing a second anomaly; and
based on a determination that the first anomaly and the second anomaly are related, add a region of the first system graph which comprises the second component to the first pattern.

19. The apparatus of claim 12, wherein the program code to extract the first pattern from the first system graph which comprises the first component comprises program code to extract a node representing the first component from the first system graph and program code to extract at least one of nodes within a threshold distance of the node representing the first component and nodes within a same subsystem as the first component.

20. The apparatus of claim 12, wherein the plurality of historical patterns comprises extracted patterns representing anomalous components previously encountered in a system.
